(19) United States
(12) Patent Application Publication
(10) Pub. No.: US 2026/0244923 A1
(43) Pub. Date: Aug. 20, 2026

(54) DATA PROCESSING METHOD AND APPARATUS, DEVICE, AND MEDIUM

(71) Applicant: Tencent Technology (Shenzhen) Company Limited, Shenzhen (CN)

(72) Inventors: Ruobing XIE, Shenzhen (CN); Zekai QU, Shenzhen (CN); Chaojun XIAO, Shenzhen (CN)

(73) Assignee: Tencent Technology (Shenzhen) Company Limited, Shenzhen (CN)

(21) Appl. No.: 19/642,130

(22) Filed: Apr. 8, 2026

Related U.S. Application Data
(63) Continuation of application No. PCT/CN2025/083412, filed on Mar. 19, 2025.

(30) Foreign Application Priority Data
Mar. 25, 2024 (CN) 202410350475.7

(51) Int. Cl. G06N 3/08; G06V 30/19

(52) U.S. Cl. CPC G06N 3/08; G06V 30/19093; G06V 30/19147

(57) ABSTRACT

A method, apparatus, and computer-readable storage medium for an improved data processing is provided. The method acquires a first text representation of each item in an item set. A historical item sequence of an interactive role is acquired. A second text representation of the historical item sequence according to the first text representation is generated. A first training sample is generated. Text prediction on a hidden position in the first training sample is performed. Feature analysis on the first training sample and a first positive sample of the interactive role is performed. The pretrained language model is trained to obtain a trained language model. A second training sample is generated according to the second text representation. Feature analysis on the second training sample and a second positive sample of the interactive role is performed. The trained language model is adjusted according to the second sample similarity.

### CROSS REFERENCE TO RELATED APPLICATION

This application is a bypass continuation application of International Patent Application No. PCT/CN2025/083412, filed on Mar. 19, 2025, which claims priority to and is based on Chinese Patent Application No. 202410350475.7, filed on Mar. 25, 2024, the disclosures of which are incorporated herein in their entireties by reference.

### FIELD

The present disclosure relates to the field of artificial intelligence technology, and in particular, to a data processing method and apparatus, a device, and a medium.

### BACKGROUND

Sequential recommendation, as an important task in recommendation systems, models historical item interaction sequences (e.g., sequences of purchased items) of various interactive roles to learn the changes in their interests, thereby predicting the next item with which each interactive role may interact. In current sequential recommendation modeling scenarios, historical item interaction sequences are used to train a sequential recommendation model. The trained sequential recommendation model can extract feature representations of interactive role interests. These feature representations can then be combined with item embedding information corresponding to each item to recommend the next item for the interactive role. It can be seen that the quality of the item embedding information directly affects the recommendation performance of the trained sequential recommendation model. Currently, item embedding information is initialized either randomly or using vectors obtained by vectorizing item text representations with a network model. However, due to the significant representation disparity between the item text representations and the historical item interaction sequences, the effectiveness of the item embedding information is compromised.

### SUMMARY

Provided are a data processing method and apparatus, a device, and a medium, which can fully utilize prior knowledge in a pretrained language model, thereby enhancing effectiveness of an item embedding representation.

According to an aspect of some embodiments of the present disclosure, a data processing method includes acquiring a first text representation of each item in an item set, acquiring a historical item sequence of an interactive role, and generating a second text representation of the historical item sequence according to the first text representation; generating a first training sample according to the second text representation, and performing text prediction on a hidden position in the first training sample according to a pretrained language model to obtain a prediction probability of the hidden position; performing feature analysis on the first training sample and a first positive sample of the interactive role according to the pretrained language model to obtain a first sample similarity; training the pretrained language model according to the first sample similarity and the prediction probability of the hidden position to obtain a trained language model; generating a second training sample according to the second text representation, and performing feature analysis on the second training sample and a second positive sample of the interactive role according to the trained language model to obtain a second sample similarity; and adjusting the trained language model according to the second sample similarity to obtain an adjusted pretrained language model, the adjusted pretrained language model being configured to initialize an embedding representation of an item

According to an aspect of some embodiments of the present disclosure, a data processing apparatus includes at least one memory configured to store program code; and at least one processor configured to read the program code and operate as instructed by the program code, the program code including: a first text acquisition code configured to cause the at least one of the at least one processor to acquire a first text representation of each item in an item set, acquire a historical item sequence of an interactive role, and generate a second text representation of the historical item sequence according to the first text representation; a second text prediction code configured to cause the at least one of the at least one processor to generate a first training sample according to the second text representation, and perform text prediction on a hidden position in the first training sample according to a pretrained language model to obtain a prediction probability of the hidden position; a first item comparison code configured to cause the at least one of the at least one processor to perform feature analysis on the first training sample and a first positive sample of the interactive role according to the pretrained language model to obtain a first sample similarity; a model pretraining code configured to cause the at least one of the at least one processor to train the pretrained language model according to the first sample similarity and the prediction probability of the hidden position to obtain a trained language model; a second item comparison code configured to cause the at least one of the at least one processor to generate a second training sample according to the second text representation, and perform feature analysis on the second training sample and a second positive sample of the interactive role according to the trained language model to obtain a second sample similarity; and a model adjustment code configured to cause the at least one of the at least one processor to adjust the trained language model according to the second sample similarity to obtain an adjusted pretrained language model, the adjusted pretrained language model being configured to initialize an embedding representation of an item.

According to an aspect of some embodiments of the present disclosure, a non-transitory computer-readable storage medium, storing computer code which, when executed by at least one processor, causes the at least one processor to at least: acquire a first text representation of each item in an item set, acquiring a historical item sequence of an interactive role, and generating a second text representation of the historical item sequence according to the first text representation; generate a first training sample according to the second text representation, and performing text prediction on a hidden position in the first training sample according to a pretrained language model to obtain a prediction probability of the hidden position; perform feature analysis on the first training sample and a first positive sample of the interactive role according to the pretrained language model to obtain a first sample similarity; train the pretrained language model according to the first sample similarity and the prediction probability of the hidden position to obtain a trained language model; generate a second training sample according to the second text representation, and performing feature analysis on the second training sample and a second positive sample of the interactive role according to the trained language model to obtain a second sample similarity; and adjust the trained language model according to the second sample similarity to obtain an adjusted pretrained language model, the adjusted pretrained language model being configured to initialize an embedding representation of an item.

Details of one or more embodiments of the present disclosure are set forth in the accompanying drawings and descriptions below. Other features and advantages of the present disclosure will be apparent from the specification, accompanying drawings, and claims.

### BRIEF DESCRIPTION OF DRAWINGS

To describe the technical solutions in the embodiments of the present disclosure more clearly, the following briefly describes the accompanying drawings required for describing the embodiments of the present disclosure. The accompanying drawings in the following description show only some embodiments of the present disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic structural diagram of a network architecture according to an embodiment of the present disclosure.

FIG. 2 is a flowchart of a data processing method according to an embodiment of the present disclosure.

FIG. 3 is a schematic diagram of text representation construction according to an embodiment of the present disclosure.

FIG. 4 is a schematic diagram of training of a pretrained language model according to an embodiment of the present disclosure.

FIG. 5 is a flowchart of item embedding initialization based on a pretrained language model according to an embodiment of the present disclosure.

FIG. 6 is a schematic diagram of training of a sequential recommendation task according to an embodiment of the present disclosure.

FIG. 7 is a schematic structural diagram of a data processing apparatus according to an embodiment of the present disclosure.

FIG. 8 is a schematic structural diagram of a computer device according to an embodiment of the present disclosure.

### DETAILED DESCRIPTION

The technical solutions in the embodiments of the present disclosure will be clearly and completely described in the following with reference to the accompanying drawings in the embodiments of the present disclosure. The described embodiments are not to be construed as a limitation to the present disclosure. All other embodiments obtained by a person of ordinary skill in the art without creative efforts shall fall within the protection scope of the present disclosure.

Embodiments of the present disclosure relate to text processing under natural language processing. In a sequential recommendation scenario, text representations of items are constructed. By performing text encoding on the text representations of the items, an item embedding representation corresponding to each item can be obtained. The item embedding representation can serve as an initialized embedding representation for each item in a sequential recommendation task, thereby enhancing the effectiveness of the item embedding representation.

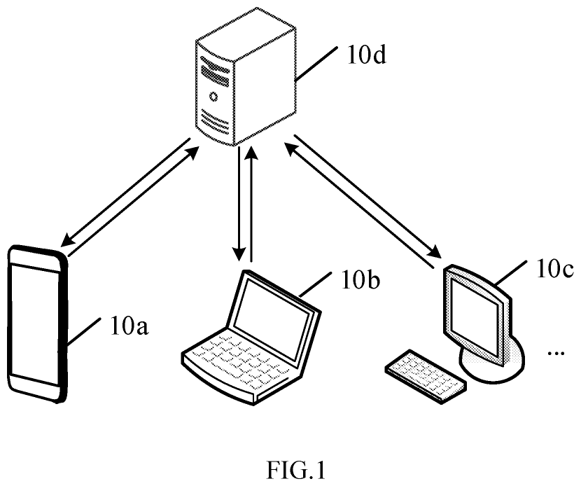

FIG. 1 is a schematic structural diagram of a network architecture according to an embodiment of the present disclosure. The network architecture may include a server 10d and a terminal cluster. The terminal cluster may include one or more terminal devices, and the quantity of terminal devices included in the terminal cluster is not limited herein. As shown in FIG. 1, the terminal cluster may include a terminal device 10a, a terminal device 10b, and a terminal device 10c, and the like. All terminal devices in the terminal cluster may be connected to the server 10d via a network connection, so that each terminal device can perform data interaction with the server 10d through the network connection.

Terminal devices in the terminal cluster may include electronic devices such as smart phones, tablet computers, notebook computers, personal digital assistants, Mobile Internet Devices (MIDs), wearable devices (e.g., smart watches, smart bracelets, and the like), smart voice interaction devices, smart home appliances (e.g., smart televisions, and the like), in-vehicle devices, and aircrafts. The present disclosure does not limit the types of the terminal devices. Each terminal device in the terminal cluster as shown in FIG. 1 may be installed with a service application. Essentially, a client of the service application is installed in each terminal device. When running in each terminal device, the service application can perform data interaction with the server 10d shown in FIG. 1 respectively. The client of the service application may be an independent client, or may be an embedded sub-client integrated into a client (e.g., a mini program). The present disclosure does not impose a limitation on this.

The service application may include, but is not limited to, applications with an item recommendation function, such as a browser, an in-vehicle application, a smart home application, a shopping application, and a content interaction application. If the terminal devices included in the terminal cluster are in-vehicle devices, the in-vehicle devices may be intelligent terminals in a smart transportation scenario, and the service applications running in the in-vehicle devices may be referred to as in-vehicle applications.

The server 10d may be an independent physical server, or a server cluster or a distributed system formed by a plurality of physical servers, or a cloud server providing basic cloud computing services such as cloud services, cloud databases, cloud computing, cloud functions, cloud storage, network services, cloud communication, middleware services, domain name services, security services, Content Delivery Networks (CDNs), and big data and artificial intelligence platforms. The present disclosure does not limit the type of the server.

One or more service applications may be installed in each terminal device shown in FIG. 1, and a sequential recommendation model may be integrated into each service application. The sequential recommendation model herein may include, but is not limited to, a Self-Attentive Sequential Recommendation Model (SASRec), a Sequential Recommendation with Bidirectional Encoder Representations from Transformer (BERT4Rec), and a Towards Universal Sequence Representation Learning for Recommender Systems (IDA-SR). The present disclosure does not limit the network structure of the sequential recommendation model. For the sequential recommendation model involved in the present disclosure, input to the sequential recommendation model may refer to an item interaction sequence feature, and the item interaction sequence feature may be formed by concatenating item embedding representations corresponding to two or more items. The item interaction sequence may refer to an item sequence generated by an interactive role in a recommendation system. A sequence obtained by concatenating, according to an arrangement order of items in the item interaction sequence, item embedding representations of all items in the item interaction sequence may be referred to as an item interaction sequence feature. An interactive role may refer to a user who provides item interaction records such as browsing, purchasing, favoring, and liking during an interaction process of a recommendation system. Each interactive role in the recommendation system may have a unique role identifier, and the role identifier may be associated with item interaction records of the interactive role in the recommendation system. Items involved in the recommendation system may include, but are not limited to, commodities, service-type items such as travel services, financial services, and catering services, and digital content-type items such as media content and documents. An item embedding representation may refer to a representation that maps an item into a continuous, low-dimensional vector space, so that a computer device can better understand and process these items. For example, items purchased by interactive role A in a recommendation system, in order of purchase time, are: item 1, item 2, item 3, and item 4. Then, an item interaction sequence of interactive role A may be represented as [item 1, item 2, item 3, item 4], and an item interaction sequence feature of interactive role A may be formed by concatenating item embedding representations respectively corresponding to item 1, item 2, item 3, and item 4.

In embodiments of the present disclosure, training sets from multiple fields may be used to pretrain a language model to obtain a pretrained language model. When resources permit, the pretrained language model may be further adjusted using a training set of a specific field. Furthermore, the trained language model can be configured to initialize an item embedding table of a sequential recommendation model, thereby enhancing the effectiveness of an item embedding representation and further improving the recommendation performance of the sequential recommendation model. The item embedding table may include item embedding representations corresponding to a plurality of items. An item identity document (ID) of each item may serve as index information for the item in the item embedding table. For example, the item ID can be configured to query, from the item embedding table, item embedding representations of items contained in an item interaction sequence of an interactive role, so as to form an item interaction sequence feature inputted to the sequential recommendation model.

The pretrained language model involved in embodiments of the present disclosure may refer to a language model trained on large-scale text data, which can be configured to learn rich language knowledge and grammatical rules. The goal of the pretrained language model is to learn language representations on unlabeled text data, enabling it to achieve strong generalization and be applied to various natural language processing tasks. The pretrained language model includes two operations: 1) a pretraining stage, in which the model can learn knowledge such as grammatical structures, semantic information, and contextual associations of texts; and 2) a fine-tuning stage, in which fine-tuning is performed on specific downstream tasks (e.g., text classification, language understanding, and the like) to adapt to requirements of specific tasks and improve performance of the model on such tasks. The pretrained language model may include, but is not limited to, Bidirectional Encoder Representations from Transformers (BERT), Generative Pretrained Transformer (GPT), Robustly optimized BERT approach (RoBERTa), Long-Document Transformer (Longformer), and the like. The present disclosure does not limit the network structure of the pretrained language model. The pretrained language model in embodiments of the present disclosure is a pretrained model, and may also be referred to as a language model or a large language model. The present disclosure does not impose a limitation on this.

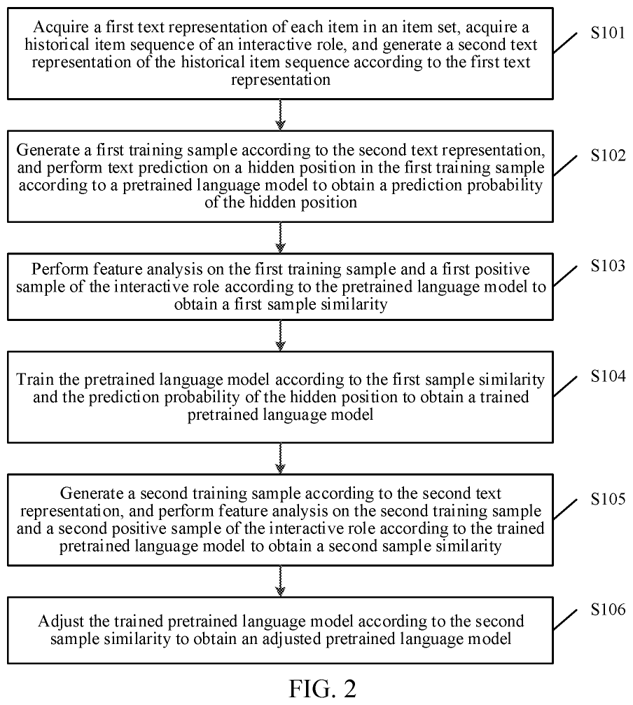

FIG. 2 is a flowchart of a data processing method according to an embodiment of the present disclosure. The data processing method may be performed by a computer device. The computer device may be a server (such as the server 10d shown in FIG. 1), or may be a terminal device (such as any terminal device in the terminal cluster shown in FIG. 1). The present disclosure does not impose a limitation on this. Referring to FIG. 2, the data processing method may include following operation S101 to operation S106.

Operation S101: Acquire a first text representation of each item in an item set, acquire a historical item sequence of an interactive role, and acquire a second text representation of the historical item sequence according to the first text representation.

In this embodiment of the present disclosure, a service application integrated with a sequential recommendation function may run in the computer device. Items in the service application are acquired, and the items in the service application are added to an item set. In addition, all interactive roles registered in the service application may be acquired, and the interactive roles registered in the service application are added to an interactive role set. Then, item interaction sequences of the interactive roles in the interactive role set may be acquired according to item interaction records of the interactive roles in the interactive role set in a service platform. A registered interactive role may refer to a user who has completed a registration process in a system or related service of a service application and can be identified and recorded by the system of the service application. For example, each user may be assigned a unique identifier for identifying user identity, and the user can use the identifier to log in to the service application and experience personalized services and functions provided by the service application. The above-mentioned item interaction records may refer to item purchase records, item sharing records, item favorite records, and the like of the interactive roles in the service platform. The present disclosure does not impose a limitation on this. Items contained in an item interaction sequence may be sorted according to item interaction time (e.g., purchase time, sharing time, favorite time, and the like). The items in the item interaction sequence are all historical interaction items of the interactive role. For ease of understanding in this embodiment of the present disclosure, the item interaction sequence of each interactive role may be referred to as a historical item sequence. Each interactive role in the interactive role set may correspond to a historical item sequence. When an interactive role in the interactive role set is a newly registered interactive role in the service application, the historical item sequence of the interactive role may be a null value. Description will be made below by taking any interactive role in the interactive role set as an example.

After acquiring the item set, the interactive role set, and the historical item sequences of the interactive roles in the interactive role set in the service platform, text representation construction may be performed on all items in the item set and the historical item sequences corresponding to the interactive roles in the interactive role set. A text representation construction process of an item may include, but is not limited to: acquiring an item type (Category), an item identifier (Brand), and an item name (Title) corresponding to each item in an item set, and combining the item type, the item identifier, and the item name corresponding to the same item to obtain a text representation of each item. The text representation at this point may be referred to as a first text representation. The item type refers to a result of classifying items according to attributes (e.g., color, size, shape, and the like), functions, purposes, or other characteristics of the items. For example, items may be classified according to characteristics such as material and purpose to obtain an item type corresponding to each item. The item type may include, but is not limited to, clothing, electronic products, cosmetics, medicine, personal care and cleaning products, office supplies, beverages, and the like. The item identifier may refer to a brand to which an item belongs, and can be used to distinguish a specific image of a product in the market, such as a trademark, logo, name, or design, from those of other similar products. The item name may refer to a name (or appellation) used to uniquely identify or distinguish an item. The item name may usually be formed by combining at least one of factors such as a manufacturer, a product category, a brand, a model, and a specification.

For a historical item sequence corresponding to each interactive role in an interactive role set, items contained in the historical item sequence may be sorted in descending order according to interaction time of the items contained in the historical item sequence to obtain a sorted historical item sequence. First text representations corresponding to the items contained in the sorted historical item sequence are concatenated to obtain a second text representation corresponding to the historical item sequence of each interactive role. In other words, the first text representations of the items contained in the historical item sequence of each interactive role may be concatenated in reverse order to form a second text representation corresponding to the historical item sequence of each interactive role. One historical item sequence may construct one second text representation. Descending order sorting may refer to a sorting mode in which interval durations between interaction time of items and a current time are sorted in ascending order. The items in the historical item sequence may be sorted in chronological order from earliest to latest interaction time. The second text representation of the historical item sequence may refer to a result obtained by concatenating first text representations of the items in an order from latest to earliest interaction time. The concatenation manner herein may be referred to as reverse-order concatenation.

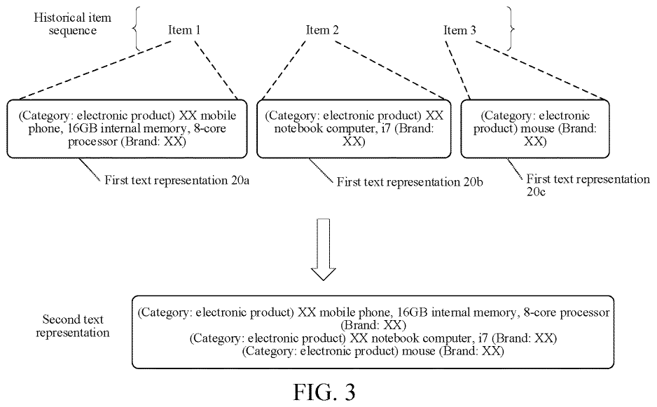

FIG. 3 is a schematic diagram of text representation construction according to an embodiment of the present disclosure. As shown in FIG. 3, it is assumed that item interaction records of interactive role A in a service platform are as follows: an interaction time of item 1 is t1; an interaction time of item 2 is t2; and an interaction time of item 3 is t3. If t1 is earlier than t2, and t2 is earlier than t3, then the historical item sequence of interactive role A may be represented as [item 1, item 2, item 3]. A first text representation 20a corresponding to item 1 may be represented as “(Category: electronic product) XX mobile phone, 16 GB internal memory, 8-core processor (Brand: XX)”; a first text representation 20b corresponding to item 2 may be represented as “(Category: electronic product) XX notebook computer, i7 (Brand: XX)”; and a first text representation 20c corresponding to item 3 may be represented as “(Category: electronic product) mouse (Brand: XX)”. Then, a second text representation corresponding to the historical item sequence of interactive role A may refer to sequentially concatenating the first text representation 20c corresponding to item 3, the first text representation 20b corresponding to item 2, and the first text representation 20a corresponding to item 1.

Operation S102: Generate a first training sample according to the second text representation, and perform text prediction on a hidden position in the first training sample according to a pretrained language model to obtain a prediction probability of the hidden position.

First training samples for training a pretrained language model may be generated from second text representations corresponding to historical item sequences of interactive roles. The first training samples herein may refer to input text representations inputted to the pretrained language model. In a pretraining stage of the pretrained language model, the pretrained language model may be trained based on the first training samples using a dual-task policy of a masked language modeling task and an item-to-item comparison task (which may be referred to as item comparison). The masked language modeling task may refer to predicting randomly masked words or phrases based on unmasked text portions in an input text representation. In this embodiment of the present disclosure, the input text representation may be the first training samples, and positions of the randomly masked words or phrases in the first training samples may be referred to as hidden positions. The item-to-item comparison task may refer to learning feature representations of different items using the pretrained language model, and calculating similarities between different items through an output layer of the pretrained language model.

A construction process of the first training samples may include, but is not limited to: determining the hidden positions in the second text representation according to a text selection ratio, and determining text representations at the hidden positions as candidate text representations; performing hiding processing on the candidate text representations to obtain hidden text representations, replacing the candidate text representations in the second text representation with the hidden text representations to obtain an initial sample, and adding a marker text (e.g., a [CLS] token, which may be added at a first position of the initial sample) to the initial sample to obtain first training samples. The hiding processing on the candidate text representations may refer to a process of performing hiding processing on the candidate text representations in the second text representation using a first hiding probability and a second hiding probability. The first hiding probability is a probability of replacing the candidate text representations in the second text representation with a mask (e.g., a [MASK] token), and the second hiding probability is a probability of replacing the candidate text representations in the second text representation with a random text representation. For example, in this embodiment of the present disclosure, the text selection ratio may be set to 15%, the first hiding probability may be set to 80%, and the second hiding probability may be set to 10%, and the like. This embodiment of the present disclosure may be set according to specific requirements of actual application scenarios, and be imposed no limitation on the specific settings of the text selection ratio, the first hiding probability, and the second hiding probability.

The above-mentioned text selection ratio may refer to a hidden text selection ratio preset for a masked language modeling task of the pretrained language model. For example, if a text length corresponding to input text of the pretrained language model (such as a second text representation) is C (C being an integer greater than 1), and a preset text selection ratio is p (p being any value greater than 0 and less than 1), then it may be determined that a total text length requiring hiding processing in the masked language modeling task is C×p. The hidden positions may refer to positions of text representations selected for hiding processing in the second text representation, i.e., positions of words or phrases selected for hiding processing. The candidate text representations may refer to all text representations selected for hiding processing in the second text representation. In other words, the candidate text representations may refer to original text representations at the hidden positions in the second text representation. The hidden text representations may refer to results obtained after performing hiding processing on the candidate text representations in the second text representation. For example, the hidden text representations may refer to replacing the candidate text representations in the second text representation with masks, random text, or the like. The initial sample may refer to a second text representation on which hiding processing has been performed on the candidate text representations. The first training sample refers to a second text representation obtained by adding a [CLS] token at a first position and performing hiding processing on candidate text representations. The hidden positions in the first training sample may be considered as positions in the first training sample where hiding processing has been completed and text prediction needs to be performed during a model training process.

In a possible embodiment, a text length may be represented by a quantity of tokens (i.e., word units or lexical items) contained in the text representation (e.g., a second text representation). In natural language processing, a token may be understood as the smallest unit having an independent meaning in a text, and refers to parts having independent lexical meanings such as words, numbers, and phrases. For example, when a text length requiring hiding processing in a masked language modeling task is C×p, C×p tokens in the second text representation need to undergo hiding processing. Therefore, positions of tokens requiring hiding processing may be determined in the second text representation, i.e., hidden positions in the second text representation are determined. In this case, the hidden position may refer to a position of a single token. For example, a position of each token in the second text representation may serve as a hidden position. The above-mentioned C×p tokens requiring hiding processing may be randomly selected from the second text representation, and the selected C×p tokens may be referred to as candidate text representations.

For example, description may be made by taking a text selection ratio of 15%, a first hiding probability of 80%, and a second hiding probability of 10% as an example. A masked language modeling task in the pretrained language model may randomly select 15% of tokens in the second text representation, and perform hiding processing on the selected tokens in the following manner: 1) replacing the selected tokens with masks ([MASK] tokens) at the first hiding probability (80%); 2) replacing the selected tokens with random tokens at the second hiding probability (10%); and 3) keeping the selected tokens unchanged at a third hiding probability (10%). Original values of the selected tokens are predicted through the pretrained language model, so as to obtain prediction probabilities corresponding to each selected token in the masked language modeling task.

In a possible embodiment, a text length may be represented by the quantity of items contained in a text representation (e.g., a second text representation), or may be understood as being represented by the quantity of first text representations contained in the second text representation. A first text representation corresponding to each item may include one or more tokens. For example, when a text length requiring hiding processing in the masked language modeling task is C×p, C×p first text representations in the second text representation need to undergo hiding processing. Therefore, positions of the first text representations requiring hiding processing may be determined in the second text representation, i.e., hidden positions in the second text representation are determined. In this case, the hidden position may refer to a position of an entire first text representation requiring hiding processing. In other words, one hidden position corresponds to one entire first text representation in the second text representation. The above-mentioned C×p first text representations requiring hiding processing may be randomly selected from the second text representation, and the selected C×p first text representations may be referred to as candidate text representations.

For example, description will be made by taking a text selection ratio of 15%, a first hiding probability of 80%, and a second hiding probability of 10% as an example. The masked language modeling task in the pretrained language model may randomly select 15% of first text representations in the second text representation, and perform hiding processing on the selected first text representations in the following manner: 1) replacing the selected first text representations with masks ([MASK] tokens) at a first hiding probability (80%); 2) replacing the selected first text representations with random first text representations at a second hiding probability (10%); and 3) keeping the selected first text representations unchanged at a third hiding probability (10%). Original values of the selected first text representations are predicted through the pretrained language model, so as to obtain prediction probabilities corresponding to each selected first text representation in the masked language modeling task.

In summary, in this embodiment of the present disclosure, the masked language modeling task in the pretrained language model may perform hiding processing on a single token in the second text representation, or may perform hiding processing on an entire first text representation in the second text representation. The present disclosure does not impose a limitation on this.

Before a text representation corresponding to an item or a historical item sequence (e.g., a first text representation or a second text representation) is inputted to the pretrained language model, a special marker text (e.g., a [CLS] token) may be added before the text representation. An output of the marker text at a last layer of the pretrained language model may serve as an embedding representation of the item or the historical item sequence for subsequent model training and item embedding initialization. Adding the marker text facilitates the model to learn bidirectional semantic knowledge in the historical item sequence. For example, assuming that a second text representation corresponding to a historical item sequence is X₁={T₁, T₂ . . . Tₙ}, then before the second text representation corresponding to the historical item sequence is inputted to a pretrained language model, a marker text needs to be added, i.e., X₂={[CLS], T₁, T₂ . . . Tₙ}, where X₁ represents the second text representation corresponding to the certain historical item sequence, and T₁, T₂ . . . Tₙ represent first text representations of a first item, a second item, . . . , and an n^{th} item in the second text representation, respectively. A text representation obtained after adding the marker text (the [CLS] token) to the second text representation X₁ is denoted as X₂. In X₁={T₁, T₂ . . . Tₙ} and X₂={[CLS], T₁, T₂ . . . Tₙ}, an interaction time of an item corresponding to T₁ is later than that of an item corresponding to T₂, and the interaction time of the item corresponding to T₂ is later than that of an item corresponding to T₃, and so on. An interaction time of an item corresponding to Tₙ is the earliest in the entire sequence. In other words, X₁ and X₂ are sorted in reverse chronological order from the latest interaction time to the earliest interaction time.

In a possible embodiment, text prediction may be performed on first training samples through the pretrained language model to obtain prediction probabilities corresponding to hidden positions in the first training samples. In some embodiments, if the pretrained language model is any language model having an encoder architecture, the first training samples may be inputted to an encoder in the pretrained language model. Encoding processing is performed on the first training samples through the encoder to obtain first sample embedding representations corresponding to the first training samples. The first sample embedding representations may be configured to predict prediction probabilities of hidden positions in the first training samples. The prediction probabilities herein may refer to probabilities, in a masked language modeling task of the pretrained language model, of predicting selected candidate text representations (tokens or first text representations) based on text representations in the first training samples excluding the hidden positions. The encoder may be configured to learn semantic associations between first text representations in the first training samples excluding the hidden positions, so as to obtain the first sample embedding representations corresponding to the first training samples. The encoder may be configured to perform bidirectional encoding on the first training samples, which can improve effectiveness of the first sample embedding representations.

Operation S103: Perform feature analysis on the first training sample and a first positive sample of the interactive role according to the pretrained language model to obtain a first sample similarity.

In a pretraining stage of the pretrained language model, an item-to-item comparison task may use a first text representation of a next real interaction item of the same interactive role in sequential recommendation as a positive sample, and use first text representations of other items in the same batch except the next real interaction item of the same interactive role as negative samples. This embodiment of the present disclosure involves large-scale first training samples. To improve training efficiency of the pretrained language model, the large-scale first training samples may be subjected to batch training. For example, the large-scale first training samples may be divided into a plurality of batches, and one batch of first training samples may be inputted in each training session to train network parameters of the pretrained language model. A real interaction item may refer to an item with which an interactive role actually interacts in a real situation.

A first training sample may be a positive sample or a negative sample. In other words, all first training samples used in a pretraining stage may include positive samples or negative samples. Positive samples and negative samples herein may be considered relative to the same interactive role. For example, in an item-to-item comparison task, for any interactive role in an interactive role set, such as interactive role A, a first text representation of a subsequent interaction item of interactive role A may be determined as a first positive sample of a first training sample currently being processed. The subsequent interaction item herein may refer to a next real interaction item of interactive role A based on its historical item sequence in sequential recommendation. For example, if a historical item sequence of the interactive role is represented as [item 1, item 2, item 3], and a next real interaction item of interactive role A in sequential recommendation is item 4, i.e., a next real interaction item after item 3, then item 4 may be used as the subsequent interaction item of interactive role A.

Assuming that a first training sample currently being processed is generated from a second text representation corresponding to a historical item sequence of interactive role A, and a first positive sample is a next real interaction item of the historical item sequence of interactive role A, then the first training sample currently being processed may be referred to as a positive sample in a pretraining stage. Assuming that a first training sample currently being processed is generated from a second text representation corresponding to a historical item sequence of interactive role A, and a first positive sample is not a next real interaction item of the historical item sequence of interactive role A, then the first training sample currently being processed may be referred to as a negative sample in the pretraining stage. Assuming that a first training sample currently being processed is generated from a second text representation corresponding to a historical item sequence of another interactive role, then the first training sample currently being processed may be referred to as a negative sample in the pretraining stage. The other interactive role herein may refer to any interactive role in an interactive role set except the interactive role A. A first training sample and a first positive sample may belong to the same interactive role or may belong to different interactive roles. The present disclosure does not impose a limitation on this.

Feature analysis may refer to a process of calculating, through a pretrained language model, a feature representation of a first training sample (which may be referred to as a first sample embedding representation) and a feature representation of a first positive sample (which may be referred to as a second sample embedding representation), and calculating a similarity between the first training sample and the first positive sample using the first sample embedding representation and the second sample embedding representation. For example, a first positive sample may be inputted to a pretrained language model, and encoding processing may be performed on the first positive sample through an encoder in the pretrained language model to obtain a second sample embedding representation corresponding to the first positive sample. A role embedding representation of an interactive role may be acquired. A first sample similarity may be obtained according to the role embedding representation, the second sample embedding representation, and first sample embedding representations of first training samples. The role embedding representation may refer to a representation that maps relevant information of an interactive role (e.g., basic personal information, interested item types, browsing records, favorite records, and the like) into a continuous, low-dimensional vector space, so that a computer device can better understand and process the relevant information of the interactive role. The role embedding representation may be obtained through the pretrained language model or may be obtained through other networks. The present disclosure does not impose a limitation on this.

Assuming that the quantity of first training samples is M and M is a positive integer, then obtaining a first sample similarity according to the role embedding representation, the second sample embedding representation, and the first sample embedding representations corresponding to the first training samples may include, but is not limited to: acquiring a first feature similarity between the role embedding representation and the second sample embedding representation, and performing an exponential operation on the first feature similarity to obtain a first candidate similarity value; acquiring second feature similarities between the role embedding representation and the first sample embedding representations respectively corresponding to the first training samples, and performing an exponential operation on the second feature similarities to obtain second candidate similarity values respectively corresponding to the first training samples; and accumulating the second candidate similarity values respectively corresponding to the first training samples to obtain an accumulated similarity value, and determining a first sample similarity according to a ratio of the first candidate similarity value to the accumulated similarity value. The first sample similarity may serve as a loss of an item-to-item comparison task in the pretrained language model. A calculation manner of the first sample similarity may be expressed by the following formula

$$\begin{matrix}( 1 ) & \\ {L}_{1} = - log \frac{{e}^{sim ( {h}_{s} , {h}_{i}^{+} ) / τ}}{{\sum }_{i ∈ B} {e}^{sim ( {h}_{s} , {h}_{i} ) / τ}} & ( 1 )\end{matrix}$$

where L₁ represents a first sample similarity between an i^{th} first training sample and a first positive sample, i is a positive integer less than or equal to M, log represents a logarithmic function with base 10, hₛ represents a role embedding representation calculated through a pretrained language model, the role embedding representation herein may refer to an embedding representation corresponding to an interactive role associated with the first positive sample,

$${h}_{i}^{+}$$

represents a second sample embedding representation, calculated through the pretrained language model, of the first positive sample (i.e., the first positive sample corresponding to the i^{th} first training sample), hᵢ represents a first sample embedding representation, calculated through the pretrained language model, of the i^{th} first training sample, B may represent a batch size, τ is a hyperparameter,

$$sim ( {h}_{s} , {h}_{i}^{+} )$$

represents a cosine similarity (first feature similarity) between the role embedding representation and the second sample embedding representation, and sim(hₛ, hᵢ) represents a cosine similarity (second feature similarity) between the role embedding representation and the first sample embedding representation.

Operation S104: Train the pretrained language model according to the first sample similarity and the prediction probability of the hidden position to obtain a trained language model.

It is assumed that the quantity of hidden positions in the first training samples is N and N is a positive integer. For example, the quantity of text representations selected in the first training samples is N, or the quantity of tokens selected in the first training samples is N. A logarithmic operation is performed on prediction probabilities corresponding to the N hidden positions to obtain logarithmic probability values respectively corresponding to the hidden positions. The logarithmic probability values respectively corresponding to the hidden positions are accumulated to determine a masked language modeling loss. A calculation manner of the masked language modeling loss may be expressed by the following formula (2):

$${L}_{2} = - {\sum }_{\hat{x} ∈ m ( X )} log p ( \hat{x} \vert {X}_{∖ m ( x )} ) \qquad ( 2 )$$

where in formula (2), L₂ represents a masked language modeling loss, and X represents first training samples inputted to a pretrained language model, m(X) represents a set of all text representations on which hiding processing has been performed in the first training samples, or may be understood as a set of text representations selected in a second text representation, \hat{x} represents any text representation on which hiding processing has been performed in the first training samples, X_{\m(x)} represents text representations on which hiding processing has not been performed in the first training samples, i.e., remaining text representations in the first training samples except m(X), and p(\hat{x}|X_{\m(x)}) represents a probability that the pretrained language model predicts a hidden text representation (a selected token or a selected first text representation, and the like) in the first training samples, i.e., a prediction probability corresponding to a hidden position.

Further, a model training loss corresponding to the pretrained language model may be determined according to the masked language modeling loss and the first sample similarity. A calculation manner of the model training loss may be expressed by the following formula (3):

$${L}_{PT} = {L}_{1} + γ {L}_{2} \qquad ( 3 )$$

where in formula (3), L_{PT} may represent a model loss of the pretrained language model in a pretraining stage, and γ serves as a hyperparameter and may be used to control a weight of the masked language modeling task.

In the pretraining stage of the pretrained language model, network parameters of the pretrained language model may be iteratively trained according to the model training loss until the model training loss satisfies a training end condition, at which point training is stopped to obtain a trained language model. The training end condition herein may be that the quantity of training iterations of the pretrained language model reaches a maximum iteration count, or that the model training loss reaches a convergence condition. The present disclosure does not impose a limitation on a setting of the training end condition. When the pretrained language model satisfies the training end condition, pretraining of the pretrained language model may be stopped, and network parameters at the time of stopping training are saved. The network parameters saved herein serve as the trained language model.

Operation S105: Generate a second training sample according to the second text representation, and perform feature analysis on the second training sample and a second positive sample of the interactive role according to the trained language model to obtain a second sample similarity.

In a possible implementation, when resources permit, the pretrained language model that has completed pretraining may be selected for further adjustment in a target domain, so as to further improve performance of the pretrained language model. In a fine-tuning stage of the pretrained language model, an item-to-item comparison task may be adopted to adjust the trained language model. Training samples in the fine-tuning stage of the pretrained language model may be referred to as second training samples. The second training samples may also be generated based on second text representations corresponding to historical item sequences. The second training samples may not require hiding processing, and the second training samples are full negative samples, i.e., all second training samples are negative samples.

The first training samples and the second training samples may be selected according to attributes. The first training samples may refer to text representations having generalization attributes. The second training samples may refer to text representations having personalization attributes. In this way, both text representations with generalization attributes and text representations with personalization attributes can be obtained, which enhances embedding representations of the pretrained language model in a personalization domain while ensuring generalization performance of the pretrained language model.

A construction process of the second training samples may include, but is not limited to: adding a marker text (e.g., a [CLS] token) to second text representations to obtain second training samples, and determining a second positive sample of an interactive role. For the same interactive role, the first positive sample and the second positive sample may be first text representations of the same item. For different interactive roles, the first positive sample and the second positive sample may be first text representations of different items, or may be first text representations of the same item. Both the first positive sample and the second positive sample are relative to an interactive role. The present disclosure does not impose a limitation on this. By performing encoding processing on second training samples through the pretrained language model, third sample embedding representations of the second training samples may be obtained. By performing encoding processing on a second positive sample through the pretrained language model, a fourth sample embedding representation of the second positive sample may be obtained. A second sample similarity may be obtained according to the third sample embedding representations, the fourth sample embedding representation, and the role embedding representation of the interactive role. The second training samples used in a fine-tuning stage of the pretrained language model may be full negative samples. After a second positive sample in this stage is determined, second training samples for adjusting the pretrained language model may be determined from the item set. For example, assuming that a second positive sample is a first text representation of an item in a historical item sequence of interactive role B (for ease of understanding, this item may be referred to as a candidate item), then the second training samples may be first text representations of other items in the item set except the candidate item and an item preceding the candidate item in the historical item sequence of interactive role B. For a calculation manner of the second sample similarity, reference may be made to the foregoing calculation manner of the first sample similarity, and details are not described herein again. The calculation manner of the second sample similarity may be expressed by the following formula (4):

$${L}_{FT} = - log \frac{{e}^{sim ( {h}_{s} , {I}_{i}^{+} ) / τ}}{{\sum }_{i ∈ I} {e}^{sim ( {h}_{s} , {I}_{i} ) / τ}} \qquad ( 4 )$$

where L_{FT} represents a second sample similarity between the second training samples and the second positive sample, i.e., the loss of the item comparison task of the trained language model in the fine-tuning stage, and log represents a logarithmic function with base 10; in formula (4), hₛ represents a role embedding representation calculated by the trained language model, and the role embedding representation herein may refer to an embedding representation corresponding to an interactive role associated with the second positive sample;

$${I}_{i}^{+}$$

represents a fourth sample embedding representation of the second positive sample calculated by the trained language model; Iᵢ represents a third sample embedding representation of the second training samples calculated by the trained language model; I may represent a batch size, and τ is a hyperparameter;

$$sim ( {h}_{s} , {I}_{i}^{+} )$$

represents a cosine similarity between the role embedding representation and the fourth sample embedding representation; sim(hₛ, Iᵢ) represents a cosine similarity between the role embedding representation and the third sample embedding representation.

Operation S106: Adjust the trained language model according to the second sample similarity to obtain an adjusted pretrained language model.

In a fine-tuning stage of the pretrained language model, network parameters of the trained language model may be iteratively trained according to the second sample similarity until the second sample similarity satisfies a training end condition, at which point training is stopped to obtain an adjusted pretrained language model. The training end condition herein may be that the quantity of training iterations of the trained language model reaches a maximum iteration count, or that the second sample similarity reaches a convergence condition. The present disclosure does not impose a limitation on a setting of the training end condition. When the trained language model satisfies the training end condition, fine-tuning of the trained language model may be stopped, and network parameters at the time of stopping training are saved. The network parameters saved herein serve as the adjusted pretrained language model. The adjusted pretrained language model may be configured to initialize an embedding representation of an item.

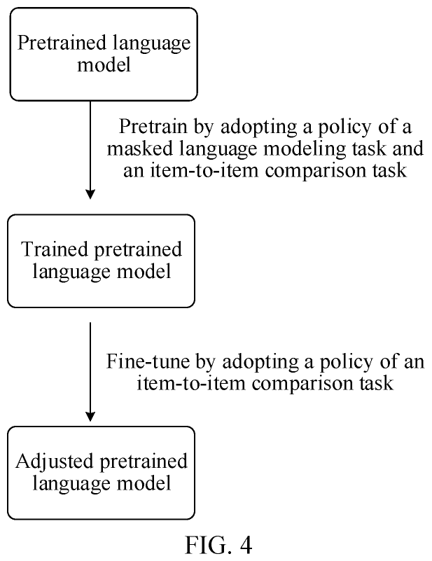

FIG. 4 is a schematic diagram of training of a pretrained language model according to an embodiment of the present disclosure. As shown in FIG. 4, a training process of a pretrained language model may include two stages, namely a pretraining stage and a fine-tuning stage. In the pretraining stage of the pretrained language model, a policy of a masked language modeling task and an item-to-item comparison task may be adopted to pretrain the pretrained language model, so as to obtain a trained language model. In the fine-tuning stage of the pretrained language model, a policy of an item-to-item comparison task may be adopted to adjust the trained language model, so as to obtain an adjusted pretrained language model.

In this embodiment of the present disclosure, a first text representation corresponding to each item in an item set is acquired, and first text representations corresponding to items contained in a historical item sequence of each interactive role are concatenated to obtain a second text representation corresponding to the historical item sequence. A first training sample for training the pretrained language model and a second training sample for adjusting the trained language model are constructed according to the second text representation. The pretrained language model is trained using a dual-task policy of masked language modeling (text prediction) and item comparison based on the first training sample to obtain a trained language model. The trained language model is adjusted using an item comparison policy based on the second training sample to obtain an adjusted pretrained language model. The adjusted pretrained language model can (i) provide an initialized item embedding representation for sequential recommendation, (ii) fully utilize prior knowledge in the pretrained language model to extract sequence features from the historical item sequence, and (iii) enhance the effectiveness of the item embedding representation.

In this embodiment of the present disclosure, the adjusted pretrained language model may be configured to perform item embedding initialization on a general sequential recommendation model.

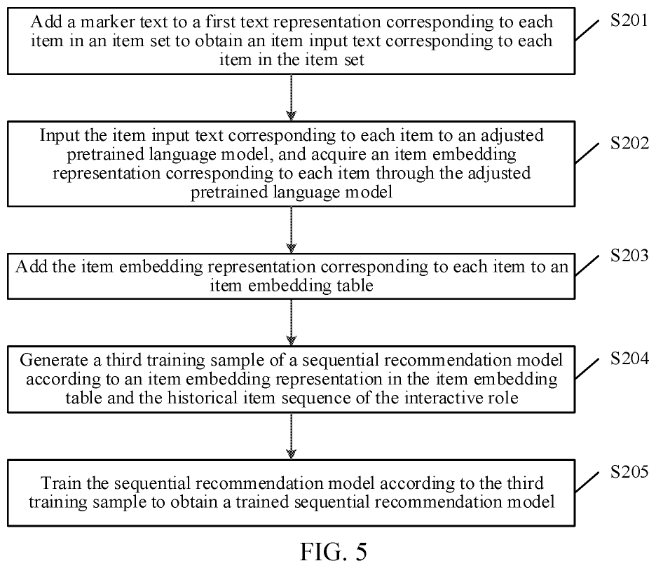

FIG. 5 is a flowchart of item embedding initialization based on a pretrained language model according to an embodiment of the present disclosure. The embodiment corresponding to FIG. 5 is an application of the adjusted pretrained language model. Referring to FIG. 5, the data processing method may include following operation S201 to operation S205.

Operation S201: Add a marker text to the first text representation corresponding to each item in the item set to obtain an item input text corresponding to each item in the item set.

In this embodiment of the present disclosure, a marker text (e.g., a [CLS] token) may be added to the first text representation corresponding to each item in the item set to obtain an item input text corresponding to each item in the item set.

Operation S202: Input the item input text corresponding to each item to the adjusted pretrained language model, and acquire an item embedding representation corresponding to each item through the adjusted pretrained language model.

For each item in the item set, an item input text may be obtained. The item input text may be inputted to the adjusted pretrained language model, and an output corresponding to the marker text (e.g., a [CLS] token) may be outputted through the adjusted pretrained language model as an item embedding representation of the item. In the same manner, an item embedding representation corresponding to each item in the item set may be acquired.

Operation S203: Add the item embedding representation corresponding to each item to an item embedding table.

Each time an item embedding representation corresponding to an item in the item set is calculated, the item embedding representation of the item may be added to an item embedding table, thereby implementing initialization of the item embedding table. The item embedding table may serve as an initialized sequence feature in sequential recommendation modeling.

Operation S204: Generate a third training sample of a sequential recommendation model according to an item embedding representation in the item embedding table and the historical item sequence of the interactive role.

Operation S205: Train the sequential recommendation model according to the third training sample to obtain a trained sequential recommendation model.

Training of the sequential recommendation model includes a first stage and a second stage. The first stage is configured to train a sequence modeling task with training of the item embedding representations suspended. The second stage is configured to train the item embedding representations with training of the sequence modeling task suspended. The trained sequential recommendation model is configured to perform item recommendation.

After completing the initialization processing of the item embedding table, a two-stage training policy may be adopted to train a sequential recommendation model. In a first stage, item embedding representations in the sequential recommendation model may be frozen, and only a sequence modeling part in the model is trained. In a second stage, the sequence modeling part in the model may be frozen, and only the item embedding representations in the model are trained. During a training process of the sequential recommendation model, other training settings are consistent with original general settings of the sequential recommendation model.

Using the adjusted pretrained language model to initialize the item embedding table in the sequential recommendation model, and training the sequential recommendation model using the two-stage training policy based on the initialized item embedding table is only an example for illustration in the present disclosure. The present disclosure may also adopt other policies to train the sequential recommendation model and perform two-stage model training on the sequential recommendation model. For example, after completing the initialization of the item embedding table, all parameters of the model may be directly trained on a data set of a target domain. Alternatively, item representations obtained by encoding based on the adjusted pretrained language model may be used as additional features of each item and frozen, and added to original item embedding representations during training and inference, and all parameters in a sequence modeling model may be trained on a data set of a target domain, and the like. The present disclosure does not impose a limitation on a training policy of the sequential recommendation model.

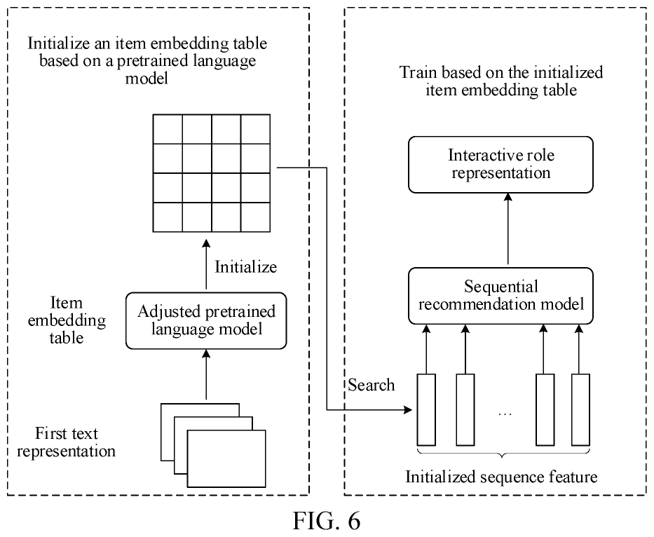

FIG. 6 is a schematic diagram of training of a sequential recommendation task according to an embodiment of the present disclosure. As shown in FIG. 6, a first text representation may be constructed for each item in an item set, and a second text representation corresponding to a historical item sequence of each interactive role in an interactive role set may be constructed based on the first text representation of each item. First training samples and second training samples are constructed based on the second text representation. The first training samples are configured to pretrain a pretrained language model to obtain a trained language model. The second training samples are configured to adjust the trained language model to obtain an adjusted pretrained language model. An item embedding table may be initialized using the adjusted pretrained language model. Based on the initialized item embedding table, an initialized sequence feature of a sequential recommendation model may be constructed. Based on the initialized sequence feature and using two-stage training on the sequential recommendation model, a trained sequential recommendation model is obtained. The trained sequential recommendation model may be iteratively trained according to an interactive role representation outputted by the model. The trained sequential recommendation model may be configured for item recommendation.

Referring to Table 1 and Table 2 below, test results obtained by testing, on different data sets (i.e., performing item recommendation using text representations in different data sets), a sequential recommendation model using the adjusted pretrained language model for item embedding table initialization and some other sequential recommendation models are shown. Other sequential recommendation models involved in this embodiment of the present disclosure may include, but are not limited to, SASRec, a Towards Universal Sequence Representation Learning for Recommender Systems (UniSRec), RECFORMER (a universal sequence representation learning model enhanced based on a pretrained language model), and the like.

TABLE 1

| | | | | | | | | | | 6) This | |
|---|---|---|---|---|---|---|---|---|---|---|---|
| 1) Data set | | 2) Indicator | | 3) SASRec | | 4) UniSRec | | 5) RECFORMER | | solution | |
| 7) | Animation | 8) | HR@1 | 9) | 40.18 | 10) | 34.37 | 11) | 36.04 | 12) | 44.50 |
| | | 13) | HR@5 | 14) | 61.58 | 15) | 54.68 | 16) | 53.90 | 17) | 69.48 |
| | | 18) | NDCG@5 | 19) | 51.42 | 20) | 44.96 | 21) | 45.27 | 22) | 57.71 |
| 23) | Sports | 24) | HR@1 | 25) | 24.91 | 26) | 25.13 | 27) | 27.26 | 28) | 32.30 |
| | | 29) | HR@5 | 30) | 41.76 | 31) | 45.09 | 32) | 45.89 | 33) | 56.08 |
| | | 34) | NDCG@5 | 35) | 33.42 | 36) | 35.40 | 37) | 36.86 | 38) | 44.70 |
| 39) | Arts | 40) | HR@1 | 41) | 37.18 | 42) | 36.81 | 43) | 39.06 | 44) | 45.86 |
| | | 45) | HR@5 | 46) | 58.51 | 47) | 59.36 | 48) | 59.60 | 49) | 71.01 |
| | | 50) | NDCG@5 | 51) | 48.35 | 52) | 48.67 | 53) | 49.88 | 54) | 59.13 |
| 55) | Instruments | 56) | HR@1 | 57) | 38.11 | 58) | 37.80 | 59) | 34.18 | 60) | 42.99 |
| | | 61) | HR@5 | 62) | 58.42 | 63) | 59.01 | 64) | 53.18 | 65) | 68.37 |
| | | 66) | NDCG@5 | 67) | 48.66 | 68) | 48.93 | 69) | 44.06 | 70) | 56.34 |
| 71) | Food | 72) | HR@1 | 73) | 15.35 | 74) | 13.62 | 75) | 17.08 | 76) | 17.58 |
| | | 77) | HR@5 | 78) | 31.80 | 79) | 28.22 | 80) | 31.37 | 81) | 35.92 |
| | | 82) | NDCG@5 | 83) | 23.62 | 84) | 21.07 | 85) | 24.41 | 86) | 27.02 |

TABLE 2

| | | | | | | | | | | 92) This | |
|---|---|---|---|---|---|---|---|---|---|---|---|
| 87) Data set | | 88) Indicator | | 89) BERT4Rec | | 90) UniSRec | | 91) RECFORMER | | solution | |
| 93) | Animation | 94) | HR@1 | 95) | 37.08 | 96) | 34.37 | 97) | 36.04 | 98) | 43.70 |
| | | 99) | HR@5 | 100) | 56.67 | 101) | 54.68 | 102) | 53.90 | 103) | 65.83 |
| | | 104) | NDCG@5 | 105) | 47.32 | 106) | 44.96 | 107) | 45.27 | 108) | 55.33 |
| 109) | Sports | 110) | HR@1 | 111) | 17.66 | 112) | 25.13 | 113) | 27.26 | 114) | 24.94 |
| | | 115) | HR@5 | 116) | 31.12 | 117) | 45.09 | 118) | 45.89 | 119) | 43.47 |
| | | 120) | NDCG@5 | 121) | 24.51 | 122) | 35.40 | 123) | 36.86 | 124) | 34.51 |
| 125) | Arts | 126) | HR@1 | 127) | 33.21 | 128) | 36.81 | 129) | 39.06 | 130) | 43.47 |
| | | 131) | HR@5 | 132) | 52.41 | 133) | 59.36 | 134) | 59.60 | 135) | 64.64 |
| | | 136) | NDCG@5 | 137) | 43.22 | 138) | 48.67 | 139) | 49.88 | 140) | 54.66 |
| 141) | Instruments | 142) | HR@1 | 143) | 36.12 | 144) | 37.80 | 145) | 34.18 | 146) | 43.45 |
| | | 147) | HR@5 | 148) | 54.20 | 149) | 59.01 | 150) | 53.18 | 151) | 64.23 |
| | | 152) | NDCG@5 | 153) | 45.53 | 154) | 48.93 | 155) | 44.06 | 156) | 54 38 |
| 157) | Food | 158) | HR@1 | 159) | 13.85 | 160) | 13.62 | 161) | 17.08 | 162) | 17.18 |
| | | 163) | HR@5 | 164) | 28.93 | 165) | 28.22 | 166) | 31.37 | 167) | 34.75 |
| | | 168) | NDCG@5 | 169) | 21.51 | 170) | 21.07 | 171) | 24.41 | 172) | 26.24 |

This solution refers to the sequential recommendation model provided in the present disclosure that adopts the adjusted pretrained language model for item embedding table initialization. Hit Ratio (HR) is configured to evaluate accuracy of items recommended by a model through prediction. The higher the two indicators HR@1 and HR@5 are, the higher the accuracy of items recommended by the model is. Normalized Discounted Cumulative Gain (NDCG) is configured to evaluate appropriateness of a recommendation order when the model performs item recommendation. The higher the indicator NDCG@5 is, the more preferentially the model can recommend, for an interactive role, items that align with interests of the interactive role.

It can be seen from results in Table 1 and Table 2 above that performance of this solution in each data set is better than that of UniSRec and RECFORMER. Meanwhile, after the item embedding table is initialized using the pretrained language model proposed in the present disclosure, performance of SASRec and BERT4Rec in sequential recommendation tasks is significantly improved. The above experimental results fully demonstrate effectiveness of this solution.

In this embodiment of the present disclosure, the adjusted pretrained language model is configured to initialize an item embedding representation, so that text information and sequence features can be better aligned, and features of a historical item interaction sequence can be accurately extracted while fully utilizing prior knowledge of the pretrained language model, thereby enhancing effectiveness of the item embedding representation and further improving a recommendation performance of the sequential recommendation model.

In the specific implementations of the present disclosure, interaction information such as item purchase records of a user on a shopping platform may be involved. When the above embodiments of the present disclosure are applied to a specific product or technology, permission or consent from a relevant institution or department or the user itself/himself/herself needs to be obtained, and favoring, using, and processing of relevant data needs to comply with relevant laws, regulations, and standards of a relevant region.

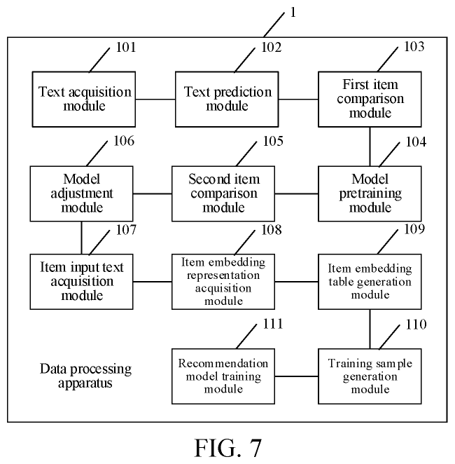

FIG. 7 is a schematic structural diagram of a data processing apparatus according to an embodiment of the present disclosure. As shown in FIG. 7, the data processing apparatus 1 includes: a text acquisition module 101, a text prediction module 102, a first item comparison module 103, a model pretraining module 104, a second item comparison module 105, and a model adjustment module 106.

The text acquisition module 101 is configured to acquire a first text representation of each item in an item set, acquire a historical item sequence of an interactive role, and generate a second text representation of the historical item sequence according to the first text representation.

The text prediction module 102 is configured to generate a first training sample according to the second text representation, and perform text prediction on a hidden position in the first training sample according to a pretrained language model to obtain a prediction probability of the hidden position.

The first item comparison module 103 is configured to perform feature analysis on the first training sample and a first positive sample of the interactive role according to the pretrained language model to obtain a first sample similarity.

The model pretraining module 104 is configured to train the pretrained language model according to the first sample similarity and the prediction probability of the hidden position to obtain a trained language model.

The second item comparison module 105 is configured to generate a second training sample according to the second text representation, and perform feature analysis on the second training sample and a second positive sample of the interactive role according to the trained language model to obtain a second sample similarity.

The model adjustment module 106 is configured to adjust the trained language model according to the second sample similarity to obtain an adjusted pretrained language model, and the adjusted pretrained language model is configured to initialize an embedding representation of an item.

In one or more embodiments, the text acquisition module 101 acquires a first text representation of each item in an item set, acquires a historical item sequence of an interactive role, and generates a second text representation of the historical item sequence according to the first text representation by performing the following operations:
(i) acquiring an item type, an item identifier, and an item name of each item in an item set, and combining the item type, the item identifier, and the item name of a same item to obtain a first text representation corresponding to each item;
(ii) acquiring a historical item sequence of an interactive role, and sorting items contained in the historical item sequence in descending order according to interaction time of the items contained in the historical item sequence to obtain a sorted historical item sequence; and
(iii) concatenating the first text representations of the items contained in the sorted historical item sequence to obtain a second text representation of the historical item sequence of the interactive role.

In one or more embodiments, the text prediction module 102 generates a first training sample according to the second text representation by performing the following operations:
(i) determining the hidden position in the second text representation according to a text selection ratio, and determining a text representation at the hidden position as a candidate text representation; and
(ii) performing hiding processing on the candidate text representation to obtain a hidden text representation, replacing the candidate text representation in the second text representation with the hidden text representation to obtain an initial sample, and adding a marker text to the initial sample to obtain a first training sample.

In one or more embodiments, the text prediction module 102 performs hiding processing on a candidate text representation in the second text representation to obtain a hidden text representation by performing the following operations:
performing hiding processing on the candidate text representation using a first hiding probability and a second hiding probability to obtain a hidden text representation, wherein
the first hiding probability is a probability of replacing the candidate text representation with a mask, and the second hiding probability is a probability of replacing the candidate text representation with a random text representation.

In one or more embodiments, the text prediction module 102 performs text prediction on a hidden position in the first training sample according to a pretrained language model to obtain a prediction probability of the hidden position by performing the following operations:
(i) inputting the first training sample to the pretrained language model, and performing encoding processing on the first training sample through the pretrained language model to obtain a first sample embedding representation corresponding to the first training sample; and
(ii) performing text prediction on the hidden position in the first training sample according to the first sample embedding representation to obtain a prediction probability of the hidden position.

In one or more embodiments, the first item comparison module 103 performs feature analysis on the first training sample and a first positive sample of the interactive role according to the pretrained language model to obtain a first sample similarity by performing the following operations:
(i) determining a subsequent interaction item of the interactive role, and determining a first text representation of the subsequent interaction item as a first positive sample of the interactive role;
(ii) inputting the first positive sample to the pretrained language model, and performing encoding processing on the first positive sample through an encoder in the pretrained language model to obtain a second sample embedding representation corresponding to the first positive sample; and
(iii) obtaining a role embedding representation of the interactive role, and obtaining a first sample similarity according to the role embedding representation, the second sample embedding representation, and the first sample embedding representation corresponding to the first training sample.

In one or more embodiments, the quantity of the first training sample is M and M is a positive integer; and the first item comparison module 103 obtains a first sample similarity according to the role embedding representation, the second sample embedding representation, and the first sample embedding representation corresponding to the first training sample by performing the following operations:
(i) obtaining a first feature similarity between the role embedding representation and the second sample embedding representation, and performing an exponential operation on the first feature similarity to obtain a first candidate similarity value;
(ii) obtaining a second feature similarity between the role embedding representation and the first sample embedding representation corresponding to each first training sample, and performing an exponential operation on the second feature similarity to obtain a second candidate similarity value corresponding to each first training sample; and
(iii) accumulating the second candidate similarity value corresponding to each first training sample to obtain an accumulated similarity value, and determining a first sample similarity according to a ratio of the first candidate similarity value to the accumulated similarity value.

In one or more embodiments, the quantity of the hidden position in the first training sample is N and N is a positive integer; and

the model pretraining module 104 trains the pretrained language model according to the first sample similarity and the prediction probability of the hidden position to obtain a trained language model by performing the following operations:
(i) performing a logarithmic operation on the prediction probability of each of the N hidden positions to obtain a logarithmic probability value corresponding to each hidden position, and accumulating the logarithmic probability value corresponding to each hidden position to determine a masked language modeling loss;
(ii) determining a model training loss of the pretrained language model according to the masked language modeling loss and the first sample similarity; and
(iii) iteratively training network parameters of the pretrained language model according to the model training loss until the model training loss satisfies a training end condition, at which point training is stopped to obtain a trained language model.

In one or more embodiments, the second item comparison module 105 generates a second training sample according to the second text representation, and performs feature analysis on the second training sample and a second positive sample of the interactive role according to the trained language model to obtain a second sample similarity by performing the following operations:
(i) adding a marker text to the second text representation to obtain a second training sample, and determining a second positive sample of the interactive role;
(ii) performing encoding processing on the second training sample through the pretrained language model to obtain a third sample embedding representation of the second training sample, and performing encoding processing on the second positive sample through the pretrained language model to obtain a fourth sample embedding representation of the second positive sample; and
(iii) obtaining a second sample similarity according to the third sample embedding representation, the fourth sample embedding representation, and a role embedding representation of the interactive role.

In one or more embodiments, the data processing apparatus 1 may further include: an item input text acquisition module 107, an item embedding representation acquisition module 108, and an item embedding table generation module 109.

The item input text acquisition module 107 is configured to add a marker text to the first text representation of each item in the item set to obtain an item input text corresponding to each item in the item set.

The item embedding representation acquisition module 108 is configured to input the item input text corresponding to each item to the adjusted pretrained language model, and acquire an item embedding representation corresponding to each item through the adjusted pretrained language model.

The item embedding table generation module 109 is configured to add the item embedding representation corresponding to each item to an item embedding table.

In one or more embodiments, the data processing apparatus 1 may further include: a training sample generation module 110 and a recommendation model training module 111.

The training sample generation module 110 is configured to generate a third training sample of a sequential recommendation model according to an item embedding representation in the item embedding table and the historical item sequence of the interactive role.

The recommendation model training module 111 is configured to train the sequential recommendation model according to the third training sample to obtain a trained sequential recommendation model.

Training of the sequential recommendation model includes a first stage and a second stage. The first stage is configured to train a sequence modeling task with training of the item embedding representation suspended. The second stage is configured to train the item embedding representation with training of the sequence modeling task suspended. The trained sequential recommendation model is configured to perform item recommendation.

According to an embodiment of the present disclosure, the operations involved in the foregoing data processing method shown in FIG. 2 may be performed by various modules in the data processing apparatus 1 shown in FIG. 7. For example, operation S101 shown in FIG. 2 may be performed by the text acquisition module 101 shown in FIG. 7, operation S102 shown in FIG. 2 may be performed by the text prediction module 102 shown in FIG. 7, operation S103 shown in FIG. 2 may be performed by the first item comparison module 103 shown in FIG. 7, operation S104 shown in FIG. 2 may be performed by the model pretraining module 104 shown in FIG. 7, operation S105 shown in FIG. 2 may be performed by the second item comparison module 105 shown in FIG. 7, and operation S106 shown in FIG. 2 may be performed by the model adjustment module 106 shown in FIG. 7, and the like.

According to an embodiment of the present disclosure, each module in the data processing apparatus 1 shown in FIG. 7 may be separately or entirely combined into one or several modules to form the apparatus, or some module(s) therein may be further split into at least two units with smaller functions. The same operations may be implemented without affecting realization of technical effects of this embodiment of the present disclosure. The above-mentioned modules are divided based on logical functions. In practical applications, a function of one module may also be implemented by at least two units, or functions of at least two modules may be implemented by one module. In other embodiments of the present disclosure, the data processing apparatus 1 may also include other modules or units. In practical applications, these functions may also be implemented with assistance of other modules and may be implemented through cooperation of at least two modules.

In this embodiment of the present disclosure, a first text representation corresponding to each item in an item set is acquired, and first text representations corresponding to items contained in a historical item sequence of each interactive role are concatenated to obtain a second text representation corresponding to the historical item sequence. A first training sample for training the pretrained language model and a second training sample for adjusting the trained language model are constructed according to the second text representation. The pretrained language model is trained using a dual-task policy of masked language modeling (text prediction) and item comparison based on the first training sample to obtain a trained language model. The trained language model is adjusted using an item comparison policy based on the second training sample to obtain an adjusted pretrained language model. The adjusted pretrained language model can provide an initialized item embedding representation for sequential recommendation, can fully utilize prior knowledge in the pretrained language model to extract sequence features from the historical item sequence, and can enhance the effectiveness of the item embedding representation. Initializing the item embedding table of the sequential recommendation model using the adjusted pretrained language model can improve a recommendation performance of the sequential recommendation model.

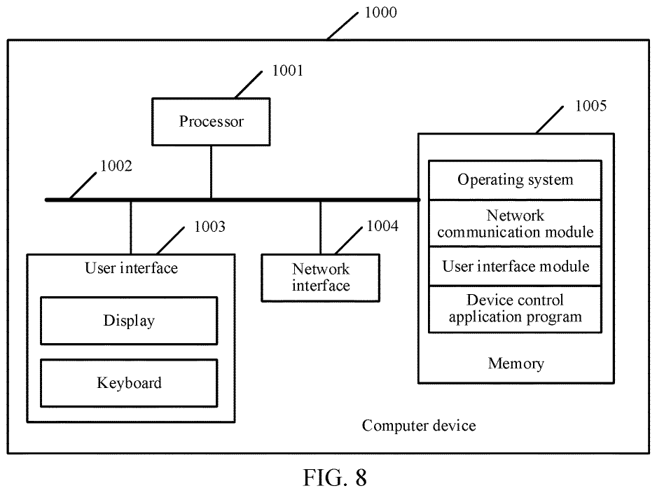

FIG. 8 is a schematic structural diagram of a computer device according to an embodiment of the present disclosure. As shown in FIG. 8, the computer device 1000 may be a terminal device, such as the terminal device 10a in the embodiment corresponding to FIG. 1, or may be a server, such as the server 10d in the embodiment corresponding to FIG. 1, which is not limited herein. For ease of understanding, the present disclosure takes the computer device being a terminal device as an example. The computer device 1000 may include: a processor 1001, a network interface 1004, and a memory 1005. In addition, the computer device 1000 may further include: a user interface 1003 and at least one communication bus 1002. The communications bus 1002 is configured to implement connection and communication between the components. The user interface 1003 may further include a standard wired interface and wireless interface. In some embodiments, the network interface 1004 may include a standard wired interface and wireless interface (such as WI-FI interface). The memory 1005 may be a high-speed random access memory (RAM) memory, or a non-volatile memory, for example, at least one magnetic disk memory. In some embodiments, the memory 1005 may alternatively be at least one storage apparatus away from the foregoing processor 1001. Referring to FIG. 8, the memory 1005 used as a computer-readable storage medium may include an operating system, a network communication module, a user interface module, and a device control application program.

The network interface 1004 in the computer device 1000 may further provide a network communication function, and the user interface 1003 may further include a display and a keyboard. In the computer device 1000 shown in FIG. 8, the network interface 1004 may provide a network communication function; the user interface 1003 is an interface configured to provide input for a user; and the processor 1001 may be configured to invoke the device control application program stored in the memory 1005 to implement:
(i) acquiring a first text representation of each item in an item set, acquiring a historical item sequence of an interactive role, and generating a second text representation of the historical item sequence according to the first text representation;
(ii) generating a first training sample according to the second text representation, and performing text prediction on a hidden position in the first training sample according to a pretrained language model to obtain a prediction probability of the hidden position;
(iii) performing feature analysis on the first training sample and a first positive sample of the interactive role according to the pretrained language model to obtain a first sample similarity;
(iv) training the pretrained language model according to the first sample similarity and the prediction probability of the hidden position to obtain a trained language model;
(v) generating a second training sample according to the second text representation, and performing feature analysis on the second training sample and a second positive sample of the interactive role according to the trained language model to obtain a second sample similarity; and
(vi) adjusting the trained language model according to the second sample similarity to obtain an adjusted pretrained language model, the adjusted pretrained language model being configured for initializing an embedding representation of an item.

The computer device 1000 described in this embodiment of the present disclosure can implement the descriptions of the data processing method in the foregoing embodiment corresponding to any one of FIG. 2 and FIG. 5, and can also implement the descriptions of the data processing apparatus 1 in the foregoing embodiment corresponding to FIG. 7, which will not be repeated here. In addition, the description of beneficial effects of the same method will not be repeated here.

In addition, it needs to be pointed out that an embodiment of the present disclosure further provides a computer-readable storage medium, the computer-readable storage medium stores the computer program executed by the foregoing data processing apparatus 1, and the computer program includes program instructions. When executing the program instructions, the processor can implement the foregoing descriptions of the data processing method in the embodiment corresponding to any one of FIG. 2 and FIG. 5, which will not be repeated here. In addition, the description of beneficial effects of the same method will not be repeated here. The foregoing storage medium may include a magnetic disc, an optical disc, a read-only memory (ROM), a random access memory (RAM), or the like. For technical details that are not disclosed in the embodiments of the computer-readable storage medium included in the present disclosure, reference may be made to the descriptions about the method embodiments of the present disclosure. In an example, the program instructions may be deployed to be executed on a computer device, or deployed to be executed on a plurality of computer devices at the same location, or deployed to be executed on a plurality of computer devices that are distributed in a plurality of locations and interconnected through a communication network. The plurality of computer devices that are distributed in the plurality of locations and interconnected through the communication network may form a blockchain system.

In addition, the embodiments of the present disclosure further provide a computer program product or computer program. The computer program product or computer program may include computer instructions, and the computer instructions may be stored in a computer-readable storage medium. A processor of a computer device reads the computer instructions from the computer-readable storage medium, and may execute the computer instructions, to cause the computer device to perform the descriptions of the data processing method in the embodiment corresponding to any one of FIG. 2 and FIG. 5, which will not be repeated here. In addition, the description of beneficial effects of the same method will not be repeated here. For technical details that are not disclosed in the computer program product or computer program embodiment of the present disclosure, refer to the descriptions of the method embodiments of the present disclosure.

The terms “first” and “second” in the specification, claims, and accompanying drawings of the embodiments of the present disclosure are used for distinguishing between different media content, and are not used for describing a specific sequence. In addition, the terms “include” and any variant thereof are intended to cover a non-exclusive inclusion. For example, a process, method, apparatus, product, or device that includes a series of operations or units is not limited to the listed operations or units; and instead, further includes an operation or unit that is not listed, or further includes another operation or unit that is intrinsic to the process, method, apparatus, product, or device.

A person skilled in the art may understand that, units and algorithm operations of the examples described in the foregoing disclosed embodiments may be implemented by electronic hardware, computer software, or a combination thereof. To clearly describe the interchangeability between the hardware and the software, the foregoing has generally described compositions and operations of each example based on functions. Whether the functions are executed in a mode of hardware or software depends on particular applications and design constraint conditions of the technical solutions. A person skilled in the art may use different methods to implement the described functions for each particular application, but it is not considered that the implementation goes beyond the scope of the present disclosure.

The methods and related apparatuses according to the embodiments of the present disclosure are described with reference to the method flowcharts and/or schematic structural diagrams according to the embodiments of the present disclosure. Each process and/or block in the method flowcharts and/or schematic structural diagrams and the combination of process and/or block in the flowcharts and/or block diagrams can be implemented by computer program instructions. These computer program instructions can be provided to the processors of general-purpose computers, special-purpose computers, embedded processing units or other programmable data processing devices to generate a machine, so that the instructions executed by the processors of computers or other programmable data processing devices generate apparatuses for implementing the functions specified in one or more processes of the flowcharts and/or one or more blocks of the schematic structural diagrams. The computer program instructions may alternatively be stored in a computer-readable memory that can guide a computer or another programmable data processing device to operate in a specific manner, so that the instructions stored in the computer-readable memory generate an artifact including an instruction apparatus. The instruction apparatus implements the functions specified in one or more processes of the flowcharts and/or one or more blocks of the schematic diagrams of the structures. These computer program instructions may also be loaded onto a computer or other programmable data processing devices to enable a series of operation steps to be executed on the computer or other programmable devices to generate processing implemented by the computer, so that the instructions executed on the computer or other programmable devices provide steps for implementing the functions specified in one or more processes of the flowcharts and/or one or more blocks of the schematic structural diagrams.

In the embodiment of the present disclosure, the term “module” or “unit” refers to a computer program with a preset function or a part of the computer program and works, together with other related parts, to implement a preset target, and may be completely or partially implemented using software, hardware (for example, a processing circuit or a memory) or a combination thereof. Similarly, one processor (or a plurality of processors or memories) may be configured to implement one or more modules or units. In addition, each module or unit may be a part of an overall module or unit including a function of the module or unit.

What are disclosed above are merely exemplary embodiments of the present disclosure, and certainly are not intended to limit the scope of the claims of the present disclosure. Therefore, equivalent variations made in accordance with the claims of the present disclosure shall still fall within the scope of the present disclosure.

What is claimed is:

1. A data processing method, performed by a computer device, the method comprising:
acquiring a first text representation of each item in an item set, acquiring a historical item sequence of an interactive role, and generating a second text representation of the historical item sequence according to the first text representation;
generating a first training sample according to the second text representation, and performing text prediction on a hidden position in the first training sample according to a pretrained language model to obtain a prediction probability of the hidden position;
performing feature analysis on the first training sample and a first positive sample of the interactive role according to the pretrained language model to obtain a first sample similarity;
training the pretrained language model according to the first sample similarity and the prediction probability of the hidden position to obtain a trained language model;
generating a second training sample according to the second text representation, and performing feature analysis on the second training sample and a second positive sample of the interactive role according to the trained language model to obtain a second sample similarity; and
adjusting the trained language model according to the second sample similarity to obtain an adjusted pretrained language model, the adjusted pretrained language model being configured to initialize an embedding representation of an item.

2. The method according to claim 1, wherein the acquiring a first text representation of each item in an item set, acquiring a historical item sequence of an interactive role, and generating a second text representation of the historical item sequence according to the first text representation comprises:
acquiring an item type, an item identifier, and an item name of each item in the item set, and combining the item type, the item identifier, and the item name of a same item to obtain the first text representation corresponding to each item;
acquiring the historical item sequence of an interactive role, and sorting items contained in the historical item sequence in descending order according to interaction time of the items contained in the historical item sequence to obtain a sorted historical item sequence; and
concatenating the first text representation of each of the items contained in the sorted historical item sequence to obtain the second text representation of the historical item sequence.

3. The method according to claim 1, wherein the generating a first training sample according to the second text representation comprises:
determining the hidden position in the second text representation according to a text selection ratio, and determining a text representation at the hidden position as a candidate text representation; and
performing hiding processing on the candidate text representation to obtain a hidden text representation, replacing the candidate text representation in the second text representation with the hidden text representation to obtain an initial sample, and adding a marker text to the initial sample to obtain the first training sample.

4. The method according to claim 3, wherein the performing hiding processing on the candidate text representation to obtain a hidden text representation comprises:
performing hiding processing on the candidate text representation using a first hiding probability and a second hiding probability to obtain a hidden text representation, wherein
the first hiding probability is a probability of replacing the candidate text representation with a mask, and the second hiding probability is a probability of replacing the candidate text representation with a random text representation.

5. The method according to claim 1, wherein the performing text prediction on a hidden position in the first training sample according to a pretrained language model to obtain a prediction probability of the hidden position comprises:
inputting the first training sample to the pretrained language model, and performing encoding processing on the first training sample through the pretrained language model to obtain a first sample embedding representation corresponding to the first training sample; and
performing text prediction on the hidden position in the first training sample according to the first sample embedding representation to obtain a prediction probability of the hidden position.

6. The method according to claim 1, wherein the performing feature analysis on the first training sample and a first positive sample of the interactive role according to the pretrained language model to obtain a first sample similarity comprises:
determining a subsequent interaction item of the interactive role, and determining a first text representation of the subsequent interaction item as a first positive sample of the interactive role;
inputting the first positive sample to the pretrained language model, and performing encoding processing on the first positive sample through an encoder in the pretrained language model to obtain a second sample embedding representation corresponding to the first positive sample; and
obtaining a role embedding representation of the interactive role, and obtaining the first sample similarity according to the role embedding representation, the second sample embedding representation, and the first sample embedding representation corresponding to the first training sample.

7. The method according to claim 6, wherein a quantity of the first training sample is M, and M is a positive integer; and
the obtaining a first sample similarity according to the role embedding representation, the second sample embedding representation, and the first sample embedding representation corresponding to the first training sample comprises:
obtaining a first feature similarity between the role embedding representation and the second sample embedding representation, and performing an exponential operation on the first feature similarity to obtain a first candidate similarity value;
obtaining the second feature similarity between the role embedding representation and the first sample embedding representation corresponding to each first training sample, and performing an exponential operation on the second feature similarity to obtain a second candidate similarity value corresponding to each first training sample; and
accumulating the second candidate similarity value corresponding to the each first training sample to obtain an accumulated similarity value, and determining a first sample similarity according to a ratio of the first candidate similarity value to the accumulated similarity value.

8. The method according to claim 1, wherein a quantity of the hidden position in the first training sample is N, and N is a positive integer; and
the training the pretrained language model according to the first sample similarity and the prediction probability of the hidden position to obtain a trained language model comprises:
performing a logarithmic operation on the prediction probability of each of the N hidden positions to obtain a logarithmic probability value corresponding to each hidden position, and accumulating the logarithmic probability value corresponding to the each hidden position to determine a masked language modeling loss;
determining a model training loss of the pretrained language model according to the masked language modeling loss and the first sample similarity; and
iteratively training network parameters of the pretrained language model according to the model training loss until the model training loss satisfies a training end condition, at which point training is stopped to obtain a trained language model.

9. The method according to claim 7, wherein the generating a second training sample according to the second text representation, and performing feature analysis on the second training sample and a second positive sample of the interactive role according to the trained language model to obtain a second sample similarity comprises:
adding a marker text to the second text representation to obtain a second training sample, and determining a second positive sample of the interactive role;
performing encoding processing on the second training sample through the pretrained language model to obtain a third sample embedding representation of the second training sample, and performing encoding processing on the second positive sample through the pretrained language model to obtain a fourth sample embedding representation of the second positive sample; and
obtaining the second sample similarity according to the third sample embedding representation, the fourth sample embedding representation, and the role embedding representation of the interactive role.

10. The method according to claim 1, wherein the method further comprises:
adding a marker text to the first text representation of each item in the item set to obtain an item input text corresponding to each item in the item set;
inputting the item input text corresponding to each item to the adjusted pretrained language model, and acquiring an item embedding representation corresponding to each item through the adjusted pretrained language model; and
adding the item embedding representation corresponding to each item to an item embedding table.

11. The method according to claim 1, wherein the method further comprises:
generating a third training sample of a sequential recommendation model according to an item embedding representation in the item embedding table and the historical item sequence of the interactive role; and
training the sequential recommendation model according to the third training sample to obtain a trained sequential recommendation model, wherein
training of the sequential recommendation model comprises a first stage and a second stage, wherein the first stage is configured to train a sequence modeling task with training of the item embedding representation suspended, the second stage is configured to train the item embedding representation with training of the sequence modeling task suspended, and the trained sequential recommendation model is configured to perform item recommendation.

12. A data processing apparatus, comprising:
at least one memory configured to store program code; and
at least one processor configured to read the program code and operate as instructed by the program code, the program code comprising:
a first text acquisition code configured to cause the at least one of the at least one processor to acquire a first text representation of each item in an item set, acquire a historical item sequence of an interactive role, and generate a second text representation of the historical item sequence according to the first text representation;
a second text prediction code configured to cause the at least one of the at least one processor to generate a first training sample according to the second text representation, and perform text prediction on a hidden position in the first training sample according to a pretrained language model to obtain a prediction probability of the hidden position;
a first item comparison code configured to cause the at least one of the at least one processor to perform feature analysis on the first training sample and a first positive sample of the interactive role according to the pretrained language model to obtain a first sample similarity;
a model pretraining code configured to cause the at least one of the at least one processor to train the pretrained language model according to the first sample similarity and the prediction probability of the hidden position to obtain a trained language model;
a second item comparison code configured to cause the at least one of the at least one processor to generate a second training sample according to the second text representation, and perform feature analysis on the second training sample and a second positive sample of the interactive role according to the trained language model to obtain a second sample similarity; and
a model adjustment code configured to cause the at least one of the at least one processor to adjust the trained language model according to the second sample similarity to obtain an adjusted pretrained language model, the adjusted pretrained language model being configured to initialize an embedding representation of an item.

13. The data processing apparatus according to claim 12, wherein the first text acquisition code is further configured to cause at least one of the at least one processor to:
acquire an item type, an item identifier, and an item name of each item in the item set, and combining the item type, the item identifier, and the item name of a same item to obtain the first text representation corresponding to each item;
acquire the historical item sequence of an interactive role, and sorting items contained in the historical item sequence in descending order according to interaction time of the items contained in the historical item sequence to obtain a sorted historical item sequence; and
concatenate the first text representation of each of the items contained in the sorted historical item sequence to obtain the second text representation of the historical item sequence.

14. The data processing apparatus according to claim 12, wherein the second text prediction code is further configured to cause at least one of the at least one processor to read the program code and operate as instructed by the program code, the program code further comprising:
a determining code configured to cause the at least one of the at least one processor to determine the hidden position in the second text representation according to a text selection ratio, and determining a text representation at the hidden position as a candidate text representation; and
a first performing code configured to cause the at least one of the at least one processor to perform hiding processing on the candidate text representation to obtain a hidden text representation, replacing the candidate text representation in the second text representation with the hidden text representation to obtain an initial sample, and adding a marker text to the initial sample to obtain the first training sample.

15. The data processing apparatus according to claim 14, wherein the first performing code is further configured to cause at least one of the at least one processor to read the program code and operate as instructed by the program code, the program code further comprising:
a second performing code configured to cause the at least one of the at least one processor to perform hiding processing on the candidate text representation using a first hiding probability and a second hiding probability to obtain a hidden text representation, wherein
the first hiding probability is a probability of replacing the candidate text representation with a mask, and the second hiding probability is a probability of replacing the candidate text representation with a random text representation.

16. A non-transitory computer-readable storage medium, storing computer code which, when executed by at least one processor, causes the at least one processor to at least:
acquire a first text representation of each item in an item set, acquiring a historical item sequence of an interactive role, and generating a second text representation of the historical item sequence according to the first text representation;
generate a first training sample according to the second text representation, and performing text prediction on a hidden position in the first training sample according to a pretrained language model to obtain a prediction probability of the hidden position;
perform feature analysis on the first training sample and a first positive sample of the interactive role according to the pretrained language model to obtain a first sample similarity;
train the pretrained language model according to the first sample similarity and the prediction probability of the hidden position to obtain a trained language model;
generate a second training sample according to the second text representation, and performing feature analysis on the second training sample and a second positive sample of the interactive role according to the trained language model to obtain a second sample similarity; and
adjust the trained language model according to the second sample similarity to obtain an adjusted pretrained language model, the adjusted pretrained language model being configured to initialize an embedding representation of an item.

17. The non-transitory computer-readable storage medium of claim 16, wherein the computer code further causes the at least one processor to:
acquire an item type, an item identifier, and an item name of each item in the item set, and combining the item type, the item identifier, and the item name of a same item to obtain the first text representation corresponding to each item;
acquire the historical item sequence of an interactive role, and sorting items contained in the historical item sequence in descending order according to interaction time of the items contained in the historical item sequence to obtain a sorted historical item sequence; and
concatenate the first text representation of each of the items contained in the sorted historical item sequence to obtain the second text representation of the historical item sequence.

18. The non-transitory computer-readable storage medium of claim 16, wherein the computer code further causes the at least one processor to:
determine the hidden position in the second text representation according to a text selection ratio, and determining a text representation at the hidden position as a candidate text representation; and
perform hiding processing on the candidate text representation to obtain a hidden text representation, replacing the candidate text representation in the second text representation with the hidden text representation to obtain an initial sample, and adding a marker text to the initial sample to obtain the first training sample.

19. The non-transitory computer-readable storage medium of claim 18, wherein the computer code further causes the at least one processor to:
perform hiding processing on the candidate text representation using a first hiding probability and a second hiding probability to obtain a hidden text representation, wherein
the first hiding probability is a probability of replacing the candidate text representation with a mask, and the second hiding probability is a probability of replacing the candidate text representation with a random text representation.

20. The non-transitory computer-readable storage medium of claim 16, wherein the computer code further causes the at least one processor to:
input the first training sample to the pretrained language model, and performing encoding processing on the first training sample through the pretrained language model to obtain a first sample embedding representation corresponding to the first training sample; and
perform text prediction on the hidden position in the first training sample according to the first sample embedding representation to obtain a prediction probability of the hidden position.
